(19) United States
(12) Patent Application Publication
(10) Pub. No.: US 2020/0246686 A1
(43) Pub. Date: Aug. 6, 2020

(54) Team Building And Communication Teaching Game

(71) Applicant: Teams Prosper LLC, Forest, VA (US)

(72) Inventors: Kristen Sill, Fredericksburg, VA (US); Gary Sill, Forest, VA (US)

(73) Assignee: Teams Prosper LLC, Forest, VA (US)

(21) Appl. No.: 16/777,948

(22) Filed: Jan. 31, 2020

Related U.S. Application Data
(60) Provisional application No. 62/799,876, filed on Feb. 1, 2019.

(51) Int. Cl. A63F 9/18; A63F 1/04; G09B 19/22

(52) U.S. Cl. CPC A63F 9/183; A63F 2250/1063; G09B 19/22; A63F 1/04

(57) ABSTRACT

A game necessitates the active participation of all players demanding that each of the team members effectively communicate with each of their teammates in such a way that winning can only be realized by working together. By providing particular game cards to game players, and a timer to encourage fast thinking and interaction, the players may solve a puzzle using team work and efficient communication skills.

This application claims the benefit of U.S. Provisional Application No. 62/799,876, filed on Feb. 1, 2019, which is incorporated by reference herein in its entirety.

The present invention is directed to a multi-player game puzzle that fosters team building and improves communication skills. The players compete against a clock and/or against other groups of players to solve a puzzle and win the game.

### BACKGROUND

Effective communication skills are critical to success in both professional and personal environments. Likewise, the ability for people to work together is of significant importance. Accordingly, teaching people to work together and communicate effectively is as valuable as it is challenging. Many methods have been utilized for teaching these skills.

Puzzle-solving games are well-known and have been enjoyed for many years. However, many puzzle challenges are focused on individual solutions, and when there are team-based challenges, those games may rely on one or a few players to carry a team performance. Existing puzzle games often do not require a great deal of interaction and communication.

With most current games, even games which are played by teams and designed to promote teambuilding, the strength or outspoken nature of a single team member can so detract from the teambuilding aspect of the game that the game becomes ineffective for teambuilding. As an example, a trivia game is often played by a team, but it is also often the case that a single player provides most of the answers. Another example of a team building game which allows a single individual to carry the team is an escape room type game.

### SUMMARY

The present invention is a game which necessitates the active participation of all players demanding that each of the team members effectively communicate with each of their teammates in such a way that winning can only be realized by working together. Accordingly, it is an object of the present game invention to provide a unique game which rewards effective communication and teamwork with positive emotion resulting from the excitement of winning. By providing particular game cards to game players, and a timer to encourage fast thinking and interaction, the players may solve a puzzle using team work and efficient communication skills.

In one example, a method of playing a game comprising the steps of providing an information set which is a collection of information, and a plurality of information subsets which are each unique portions of the collection of information contained in the information set; and providing a card set comprising a plurality of cards, wherein each card presents an information subset, a plurality of questions, a plurality of numbered right answers, and a plurality of numbered wrong answers; wherein no single card includes all of the information and right answers to correctly answer all of the questions presented on that single card. All of the questions of the card set relate to the information set and may only be correctly answered by examination of that information set, and all of the right answers and wrong answers are specific to the questions of the card set. A timer is set with a stop code that corresponds to the numbered right answers. A plurality of players start the game by starting the timer. Each of the plurality of players is given a different card wherein all of the cards cumulatively comprise a card set, and wherein each player may only view their own card that they were given. The players then determine a plurality of right answers by communicating with each other and then stopping the timer by entering the numbered right answers with the timer, wherein the timer will stop only if the entered right answers are correct. The timer may be a countdown timer, and the countdown timer deducts a predefined amount of time upon entry of incorrect answers with the timer. The information set may be a collection of information of various types selected from the group consisting of words, numbers, formulas, photographs, pictures, figures, maps, shapes, contours, symbols, items, sounds, colors, smells, heat, weight, texture, feel, and emotion, or any combination thereof. The information may be presentable by one or more of the means selected from the group of visual, audible, physical, digital, or virtual means, or any combination thereof. The countdown timer may comprise a compartment which opens upon entry with the timer of all of the numbered right answers, and the compartment contains a prize. The cards may be physical objects, or alternatively, the cards are digitally displayed on an electronic device. The countdown timer may be a virtual device. The method may further comprise the step of providing a plurality of shrouds, whereby each player may keep other players from seeing their card. All players may be required to provide input in selecting the right answers to enter with the timer.

### BRIEF DESCRIPTION OF THE DRAWINGS

FIG. 1 is a perspective view of a table and stools where an exemplary four-person game as described herein is set up and ready for play.

FIGS. 2A-E are schematic views of one example of a card set made up of four cards, FIGS. 2A-D, and a timer device, FIG. 2E, as would be positioned in the middle of the game cards.

FIGS. 3A and 3B are schematic views of an example of a card set that shows a complete picture, FIG. 3A, and then an example of a list of puzzle questions, right answers and wrong answers, FIG. 3B.

FIGS. 4A-D are schematic views of an example of a card set that uses a written word story as the puzzle content.

FIG. 5 is an example of a physical playing card with a picture puzzle piece and a set of questions and possible answers.

FIG. 6 is an example of a digital playing card with a picture puzzle piece and a set of questions and possible answers, all the same as FIG. 5, and a virtual timer and a discussion screen.

### DETAILED DESCRIPTION

The purpose and result of the present puzzle game is to build teamwork between the game participants and improve communication skills. Of course, as a game, the purpose is also to have fun while playing. As will be explained, a puzzle is created out of an information set (also referred to in shortened form as “info set”). This information set contains all of the disclosure and description to enable any person to provide right answers to questions that are presented. However, the game divides the information set into predetermined information subsets (also referred to as “info subsets”) that each contain only a portion of the disclosure and description of the information set as a whole. Players are given only the information subsets to play the game. Then the players must communicate and work together to arrive at right answers to questions that are posed by the game.

The game and its parts will be discussed more specifically in the following. In order to better understand the game, the following glossary is provided to define the various game components and actions.

### Glossary

For the purpose of clarity, the words listed below shall be defined as stated here throughout this document:
Card: A portion of a Card Set consisting of the description and disclosure of one or more but not all of the:
   Info Subsets
   Questions
   Right Answers
   Wrong Answers
A Card may not include disclosure of all of the information and Right Answers to correctly answer all of the Questions contained within that same Card. A Card may be a physical card, for instance paper or plastic, or it may alternatively be a virtual card, for instance on a digital device screen.
Card Set: A plurality of Cards that cumulatively disclose all of the description and disclosure of an Info Set along with all of its corresponding:
   Info Subsets
   Questions
   Right Answers
   Wrong answers
Info Set: Also referred to as an information set, an info set is a specific collection of information of various types which may include but shall not be limited to words, numbers, formulas, photographs, pictures, figures, maps, shapes, contours, symbols, items, sounds, colors, smells, heat, weight, texture, feel, and emotion, or any combination thereof. This information may be presentable by various means including but not limited to visual, audible, physical, digital, or virtual means or any combination thereof.
Info Subset: Also referred to as an information subset, an Info Subset is a unique portion of the specific collection of information contained in an Info Set.
Questions: A set of Questions pertaining to a specific Info Set which may only be correctly answered by an examination of that Info Set.
Right
Answers: Specific correct answers to the questions of a specific Card Set.
Wrong
Answers: Specific incorrect answers to the questions of a specific Card Set.

A countdown timer is also an integral part of the game described herein. And while the term “timer” is used, the timer device may be a processor or other electronic device that is custom made or programmed for the game. The timer, its setup, and operation are unique elements of the game. The timer is unique to this game for several reasons. First, it is unique in that once the timer is started, the players are only able to stop the timer by entering a code. Second, the timer is unique because the code which must be entered to stop the timer is specific to each Info Set. In other words, every Info Set is given a unique identification number. Setting up the timer consists of entering the Info Set identification number into the timer. The timer translates the Info Set identification number into the corresponding timer stopping code by way of looking up the code on a predetermined table of codes and identification numbers or by way of processing the identification number through a formula in order to generate a code unique to that number.

Optional variations in use of the timer include that if the players enter an incorrect code into the timer, the time will be decremented by a preselected amount of time. This decrement time can be preset or optionally adjusted during the setup of the timer at the start of a game. Another option includes that once a code is entered, if that code is incorrect, the players may choose for the timer to identify which parts of their code are incorrect in exchange for having their time further reduced. If the players elect to execute this option, the correct portions of the code are locked in and no longer editable. Once all of the identified incorrect elements of the code have been changed by the players, the players can choose to either recheck the code to see if they have any remaining wrong answers or submit the code as is. If they resubmit the code as is and the code is incorrect, then the players will not know which of their changed answers are incorrect. If the players choose to verify their code before resubmitting it, they will reduce their time, but they will also be immediately aware of which portions of the code remain incorrect. The amount of time by which the timer is reduced is adjustable during the setup of the timer. The means by which the incorrect elements of the code may be identified include but are not limited to, change of color, indicator lights, highlighting, flashing, etc. A further optional feature includes that once the timer gets to zero, it keeps counting in a negative direction. The timer may indicate that it is counting in a negative direction by changing colors, by way of a negative sign or by any other means. When the timer is used with the automatically opening compartment upon winning, the compartment may optionally not open when the timer is below zero. This feature may be turned on or off when the timer is set up. Finally, the timer may be set to allow different code lengths depending on the number of questions. The code length can be adjusted when the timer is setup. As is readily apparent, the timer is a flexible game tool that includes many optional features that may be deployed, or not, during specific games.

The puzzle game will now be explained through the use of game examples. The game starts with providing a Card Set with the number of Cards corresponding to the number of a plurality of players. Stated simply, the players will then work together to solve the puzzle and provide right answers, all the while being timed by the game timer.

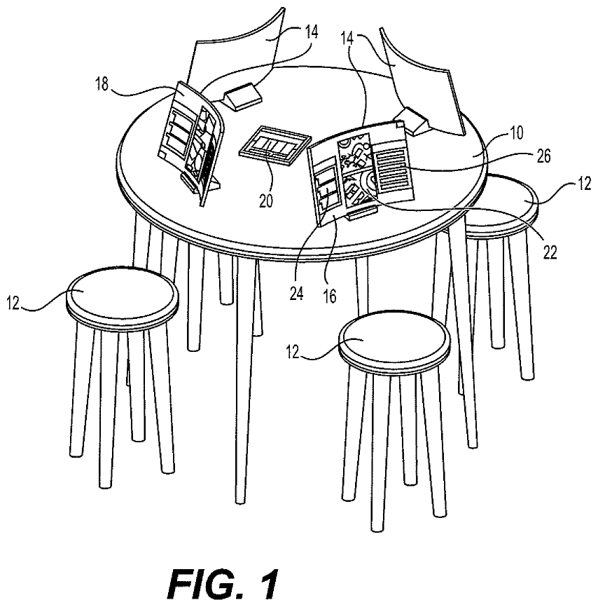

FIG. 1 illustrated a table 10 and stools 12 set around the table for four players to sit on. The table 10 has four shrouds 14 set on the top of the table together with a timer 20. The shrouds 14 as shown are curved boards that impart some privacy to each user and an info card, for example cards 16 and 18, that are visible in this view. Imagining this four-person game, there would be visible Cards visible on the curved surface of the respective shrouds 14 that are visible to a player, for instance Cards 16 and 18. As is seen on Card 16, there are three sets of items shown including an info subset 22 in the example of a picture, a set of puzzle questions 16 and a proposed set of answers 26 that are visible to a player.

### Example One

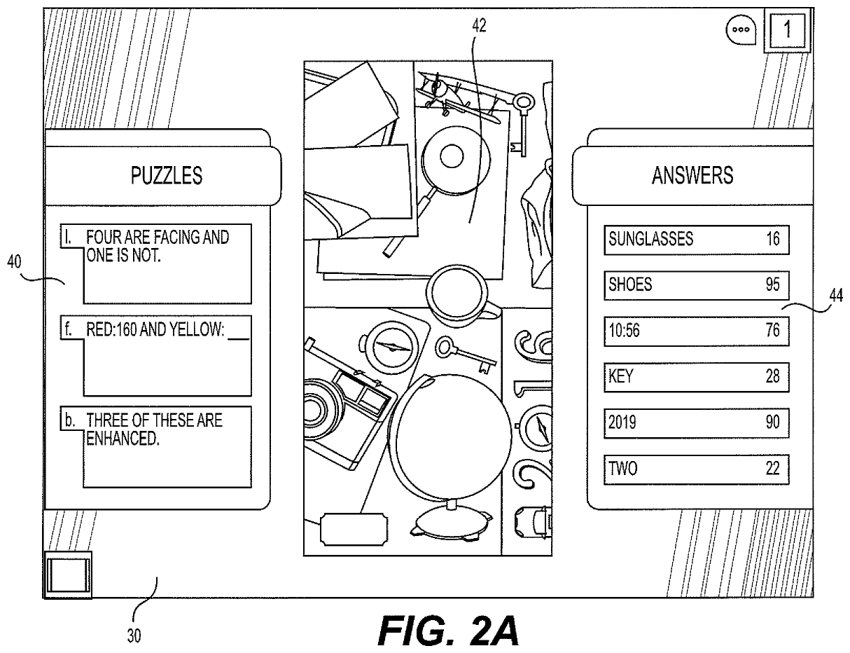

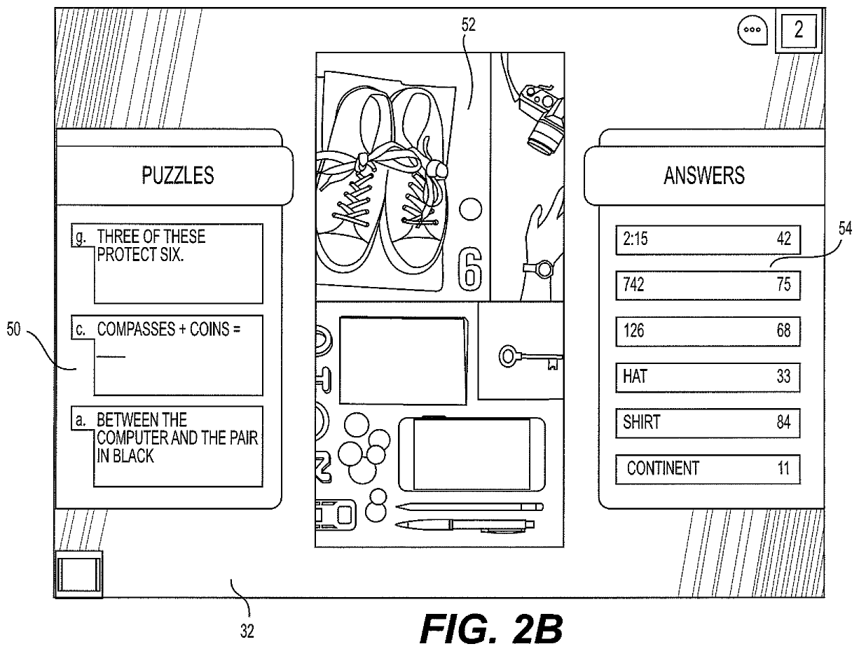

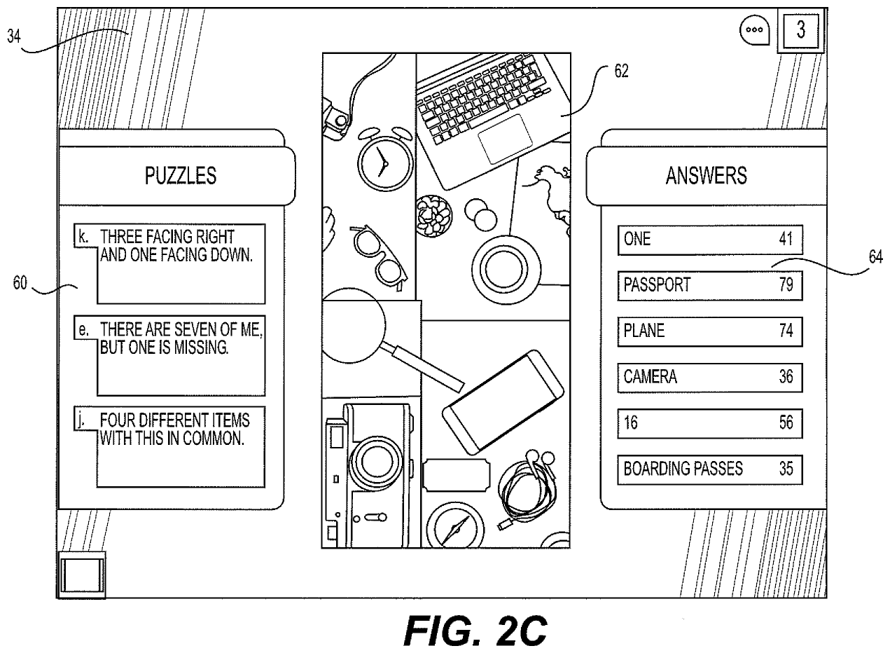

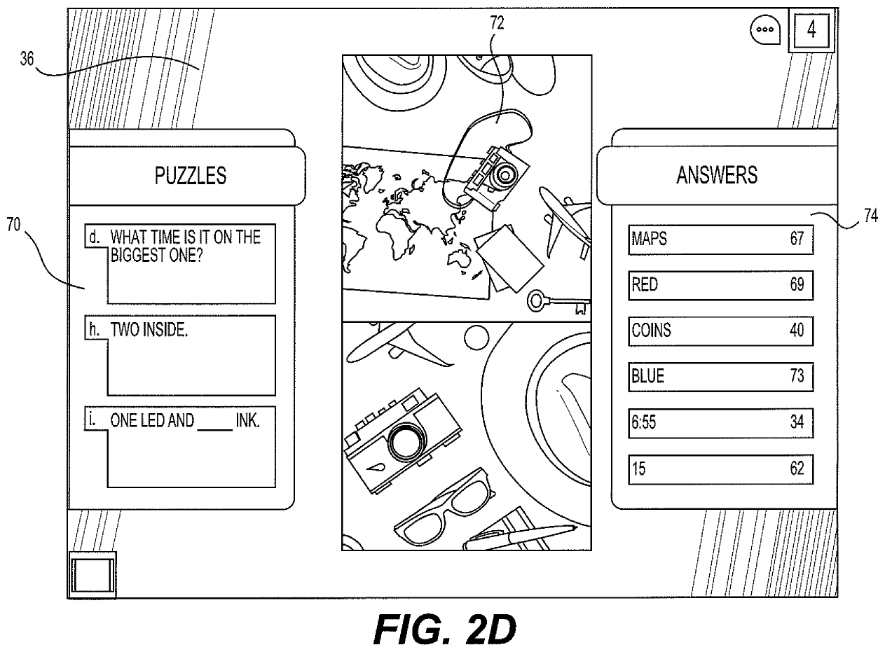

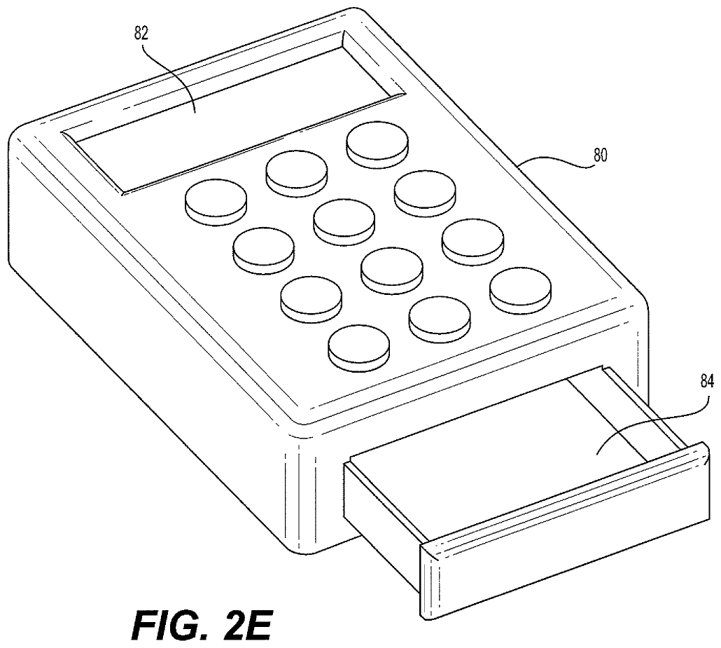

In one example of the game where there are four players, an Info Set consists of a single photograph and the corresponding Info Subsets each consist of a portion of that same photograph. As shown in FIGS. 2A-D, a set of four cards 30, 32, 34, and 36 makes up a Card Set, each Card containing a portion of the photograph 42, 52, 62, and 72 respectively, three Questions 40, 50, 60, and 70 respectively, three Right Answers, and three Wrong Answers 44, 54, 64, and 74. Each of the Right Answers and each of the Wrong Answers 44, 54, 64, and 74 on the Cards 30, 32, 34, and 36 are identified by a corresponding number.

In this example of the game, the game pieces are as follows:
Physical Card Set 30, 32, 34, and 36 (four cards for the four players)—The cards each present the information, questions and answers as noted.
Shrouds—One for each player, the shroud allows a player's card or cards as well as that player's notes to be hidden from the other players. The shroud is simply a curved board or box or other privacy structure to block the casual view of the player's card or notes.
Countdown Timer 80, FIG. 2E—The countdown timer 80 is activated at the initiation of the game and keeps track of the play time remaining. The countdown timer 80 can only be stopped by way of the players answering all of their questions correctly, thus revealing a code which must be entered into the countdown timer using a keyboard and screen 82, thereby stopping the timer and ending the game. An optional feature of this timer 80 is that the timing device contains a compartment 84 which opens upon a winning event thereby releasing a prize, token, or other item.

### Setup:

For ease of explanation, this example assumes that four players will play the game. Generally, this game is in no way limited to nor does it require four players.

To setup a game:
Each player is provided with a shroud
Each player is provided with a Card
The countdown timer is setup with the stop code corresponding to the Right Answers of Card Set in use

### Play:

In this example, the game starts when the countdown timer is started. Once the timer is started, the players seek out the Right Answers to the Questions on their Card by way of verbal communication with the other players who together have the information necessary to correctly answer all of the Questions. Once all of the Questions are answered by each of the players, the numbers corresponding to the Right Answers must be entered into the countdown timer in consecutive order to stop the timer. If the correct numbers are properly entered before the time has elapsed, the players win. Or, in a competitive game where the players are competing against other groups of players, the first player team to enter all of the correct answers will win and defeat the other player teams. An incorrect entry by the players may cause the deduction of a predefined amount of time from the countdown timer. This deduction from the game timer may vary by particular game and by the time left on the timer. (For instance, early, wrong guesses may cause larger time deductions.) The timer may continue counting down, even in a negative direction, until the players enter the correct code. Players need not take turns for any aspect of this example of the game. Players may only view their own cards. Players may only share the information on their cards by verbal means.

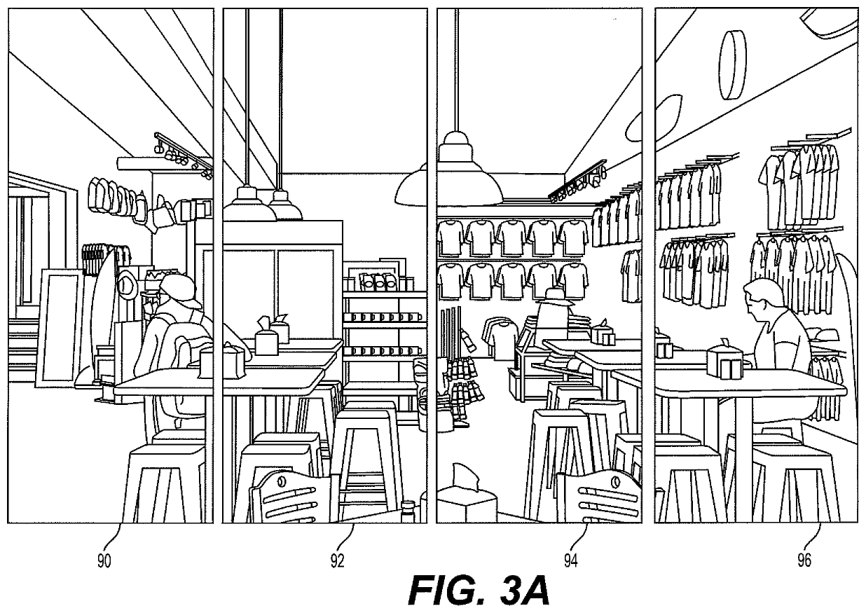

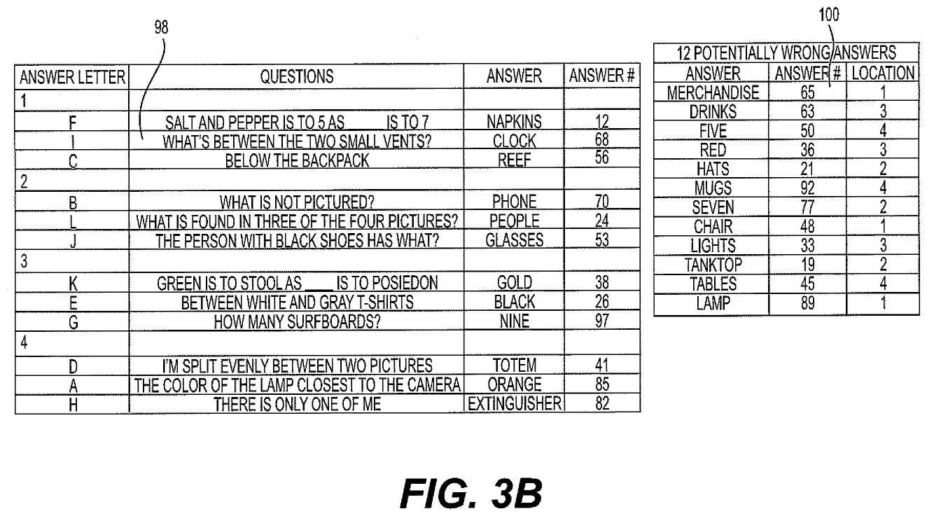

FIGS. 3A-B are an additional example of an information set that consists of a photograph/picture divided into four subset pictures 90, 92, 94, and 96, FIG. 3A. FIG. 3B illustrates four sets 98 of questions and right answers that would be divided up and assigned to a particular picture 90, 92, 94, and 96 and provided to a player. FIG. 3B also shows a set 100 of potentially wrong answers that could be used to try to throw off a player.

### Example Two

In another example of the game, an Info Set consists of a written story and the corresponding Info Subsets consist of a portion of that same story. Cards are presented to each player in digital form by way of computers, tablets, smartphones, or other means in digital form.

In this example of the game the game pieces are as follows:
Digital Card Set
Virtual Countdown Timer

### Setup:

Each player connects to a host computer through their digital device.
The host computer provides each player with a single digital Card from the same digital

Card Set.
The host computer sets up the virtual countdown timer.

### Play:

The game starts when each player indicates to the host computer that they are ready to start. At this time, the host computer starts the timer and the players begin to seek out the correct answers to their questions by verbal or written communication with the other players, who together have the information necessary to correctly answer all of the questions. If the communication is written, it may be arranged that certain words or phrases be disallowed thereby eliminating the possibility of directly sharing the written information of the Info Subsets. Once all of the questions are answered by each of the players the host computer stops the timer and the game ends. Players need not take turns for any aspect of this example of the game.

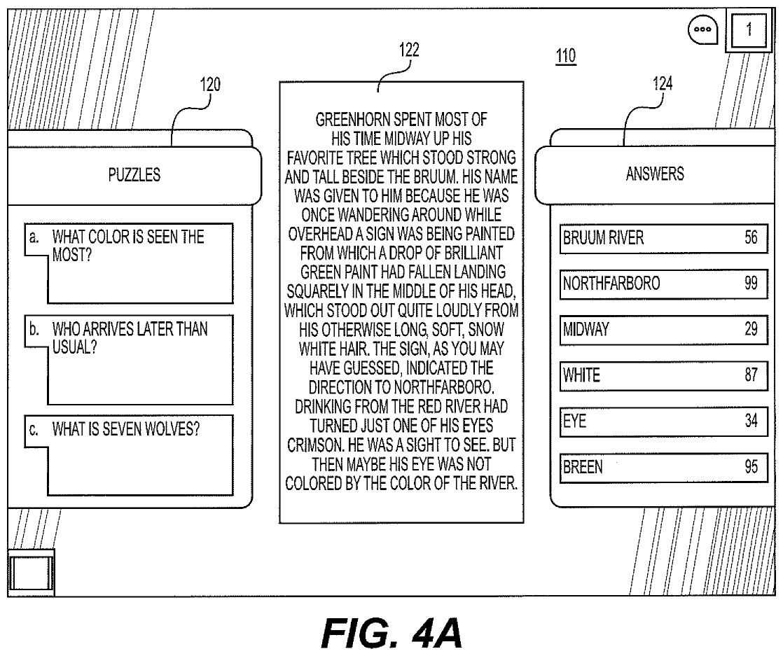

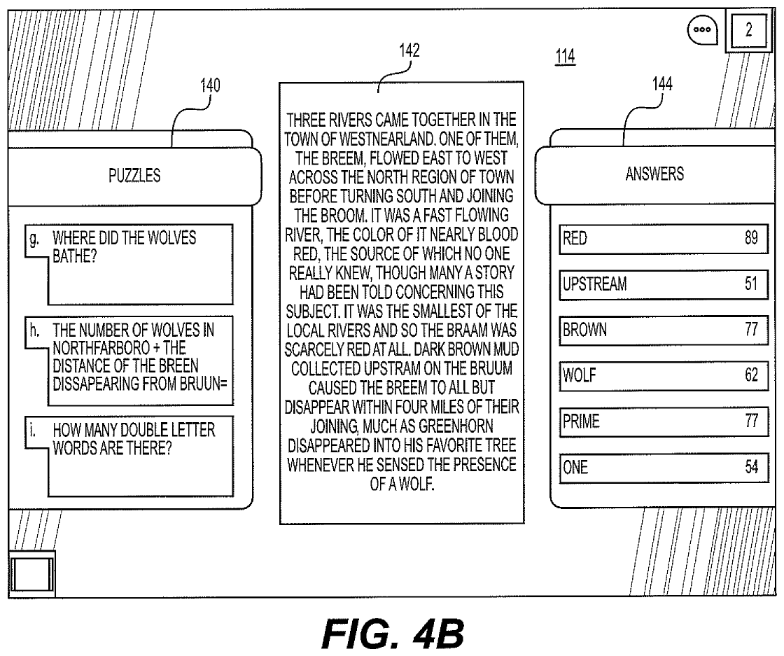

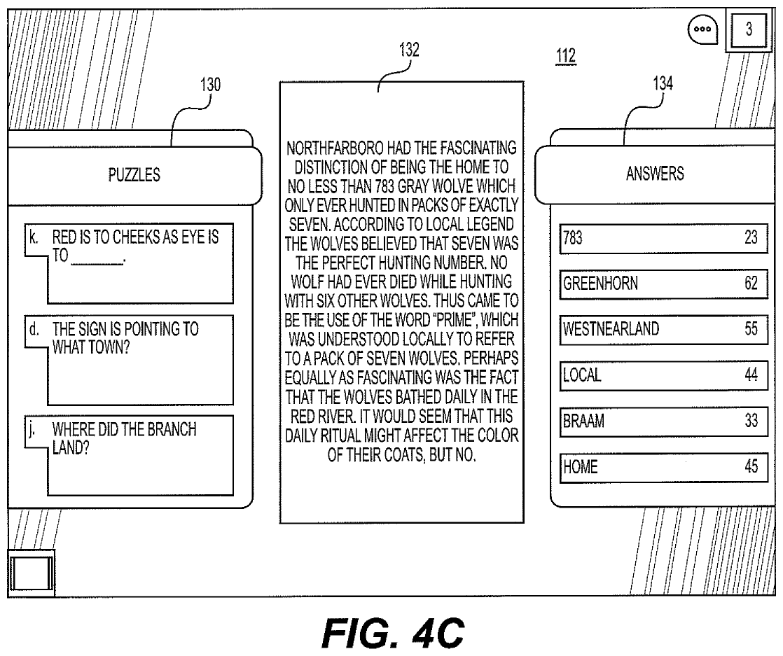

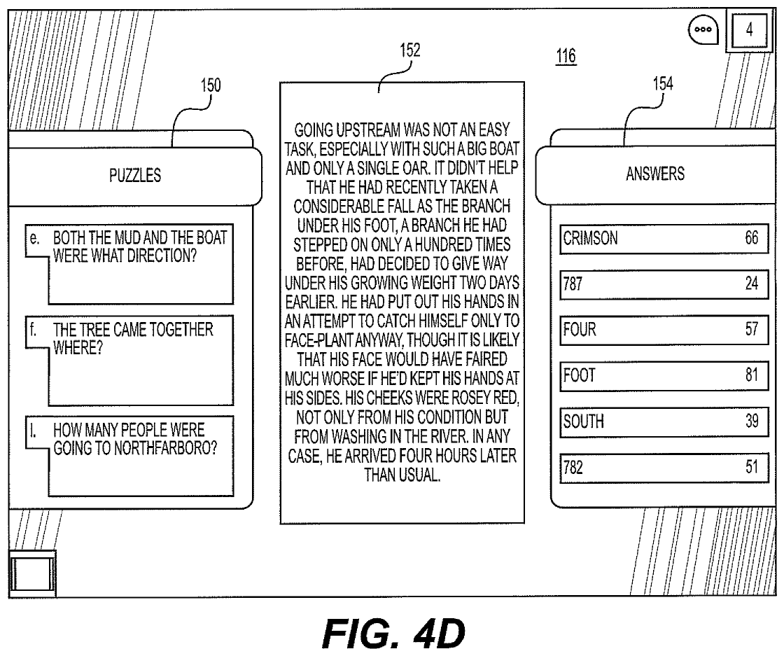

FIGS. 4A-D illustrate a Card Set that includes four Cards 110, 112, 114, and 116. This is an example of a written story game. Each of the cards 110, 112, 114, and 116 have a written section 122, 132, 142, and 152 that cumulatively amount to a complete information set. Each Card 110, 112, 114, and 116 also contains three questions 120, 130, 140, and 150 together with a set of six answers 124, 134, 144, and 154 respectively. The six answers 124, 134, 144, and 154 include a collection of right answers and wrong answers that the players must solve during the game.

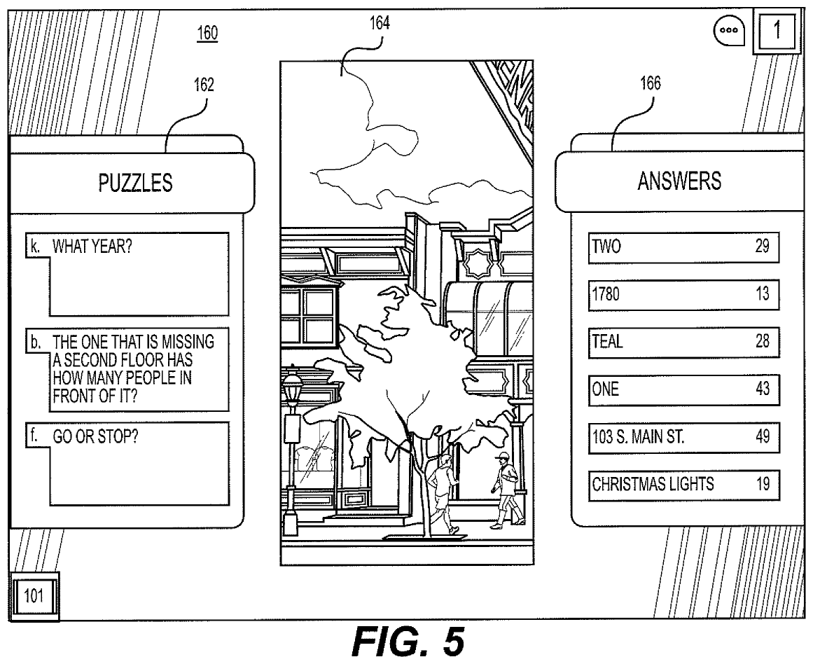

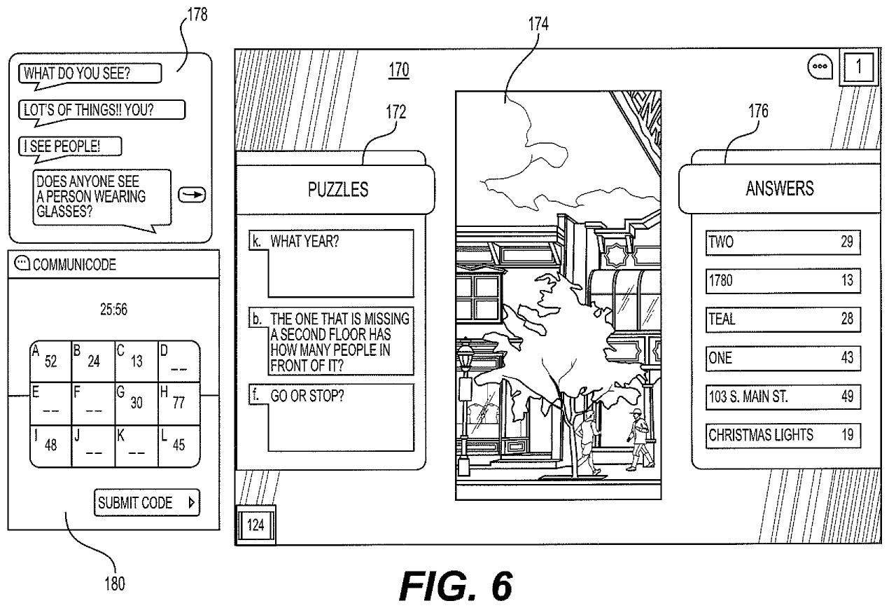

FIGS. 5 and 6 illustrate examples of a physical game Card, FIG. 5 and a digital game Card, FIG. 6. The game Card 160 in FIG. 5 is a sheet of paper or plastic and would be placed in or behind a shroud (not shown) for play. The Card 160 includes the portion of a picture 164, that makes up an information subset, in between the puzzle questions 162 and puzzle answers 166, that includes both right and wrong answers. FIG. 6 displays a digital game Card 170 showing the same picture 174 as the picture 164 in FIG. 5. The questions 172 and answers 176 are also the same as the respective questions 162 and answers 166 in FIG. 5. However, Card 170 also displays a virtual countdown timer and answer input screen 180. FIG. 6 also shows a discussion screen 178 where players may communicate with each other. In this example of FIG. 6, the communication is all electronic, so the players may be nearby or far away from each other.

The foregoing examples of the game are merely examples and do not limit the types and styles of playing the game. The possible configurations of this game are nearly unlimited. Some embodiments may include smart phone applications, while other embodiments may incorporate the use of various rooms in a home or office which will be used to keep Cards disclosed. Communication may include or, alternatively, be limited to braille, sign language, facial expression, gestures, writing, verbal, drawing pictures, or any other means.

Info Sets and Card Sets may be customized with content and subject matter suitable for specific groups or purposes. As an example, an Info Set might include content related to medical procedures for the purpose of training medical students how to properly communicate regarding such information. Another example of customization might include the use of company information which would provide for training about a company and its products/services, while simultaneously training employees better communication techniques. In yet another example, a dating version of the game could utilize Info Sets and Questions which promote dating related communication.

Since teamwork and communication are part of the game goals, it is possible to also incorporate additional rules about game participation. It could be required that every player must provide input in order to ascertain the Right Answers to the Questions. Other participation rules may be designed into the game by carefully selecting the description and disclosure in the various individual Cards and their Info Subsets.

Another optional variation includes some type of feedback after the team enters its guess for the numbered Right Answers. Especially if the timer is a digital interface, but also in some analog situations, the team may be told which of their answers are correct Right Answers and which are Wrong Answers. Or they may be told that a certain number of answers were correct without specifying which answers those were.

Other embodiments of the present invention will be apparent to those skilled in the art from consideration of the specification. It is intended that the specification and figures be considered as exemplary only, with a true scope and spirit of the invention being indicated by the following claims.

That which is claimed is:

1. A method of playing a game comprising the steps of:
providing an information set which is a collection of information, and a plurality of information subsets which are each unique portions of the collection of information contained in the information set;
providing a card set comprising a plurality of cards, wherein each card presents an information subset, a plurality of questions, a plurality of numbered right answers, and a plurality of numbered wrong answers; wherein no single card includes all of the information and right answers to correctly answer all of the questions presented on that single card;
wherein all of the questions of the card set relate to the information set and may only be correctly answered by examination of that information set, and all of the right answers and wrong answers are specific to the questions of the card set;
providing a timer that is set with a stop code that corresponds to the numbered right answers;
providing a plurality of players;
starting the game by starting the timer;
giving each of the plurality of players a different card wherein all of the cards cumulatively comprise a card set, and wherein each player may only view their own card that they were given;
determining a plurality of right answers by the players communicating with each other and then stopping the timer by entering the numbered right answers with the timer, wherein the timer will stop only if the entered right answers are correct.

2. A method of playing a game as described in claim 1,
wherein the timer is a countdown timer, and the countdown timer deducts a predefined amount of time upon entry of incorrect answers with the timer.

3. A method of playing a game as described in claim 1,
wherein the information set is a collection of information of various types selected from the group consisting of words, numbers, formulas, photographs, pictures, figures, maps, shapes, contours, symbols, items, sounds, colors, smells, heat, weight, texture, feel, and emotion, or any combination thereof.

4. A method of playing a game as described in claim 1,
wherein the information is presentable by one or more of the means selected from the group of visual, audible, physical, digital, or virtual means, or any combination thereof.

5. A method of playing a game as described in claim 2,
wherein the countdown timer comprises a compartment which opens upon entry with the timer of all of the numbered right answers, and the compartment contains a prize.

6. A method of playing a game as described in claim 1,
wherein the cards are physical objects.

7. A method of playing a game as described in claim 1,
wherein the cards are digitally displayed on an electronic device.

8. A method of playing a game as described in claim 1,
wherein the countdown timer is a virtual device.

9. A method of playing a game as described in claim 1,
further comprising the step of providing a plurality of shrouds, whereby each player may keep other players from seeing their card.

10. A method of playing a game as described in claim 1,
wherein all players must provide input in selecting the right answers to enter with the timer.
